(19) United States
(12) Patent Application Publication
(10) Pub. No.: US 2026/0108995 A1
(43) Pub. Date: Apr. 23, 2026

(54) METHOD AND MECHANICAL DEVICE FOR HANDLING A PRODUCT ASSEMBLY

(71) Applicant: TRUMPF Werkzeugmaschinen SE + Co. KG, Ditzingen (DE)

(72) Inventors: Patrick Mach, Korb (DE); Stefan Krause, Wilthen (DE); Falk Waurisch, Schmölln-Putzkau (DE)

(21) Appl. No.: 19/359,723

(22) Filed: Oct. 16, 2025

(30) Foreign Application Priority Data
Oct. 21, 2024 (DE) 102024210138.9

(51) Int. Cl. B23Q 7/00

(52) U.S. Cl. CPC B23Q 7/006

(57) ABSTRACT

A method for handling a releasable product assembly having at least one workpiece part and a residual grid includes releasing the at least one workpiece part from the residual grid by using at least one vibration generator at a separation station, and fixing the product assembly to a holding device, which engages underneath the product assembly at an edge side thereof with at least one holding member. The releasing the at least one workpiece part from the residual grid takes place on the product assembly fixed by the holding device.

### CROSS REFERENCE TO RELATED APPLICATIONS

This application claims benefit to German Patent Application No. DE 10 2024 210 138.9, filed on Oct. 21, 2024, which is hereby incorporated by reference herein.

### FIELD

Embodiments of the present invention relate to a method for handling a releasable product assembly having at least one workpiece part and a residual grid. Embodiments of the present invention also relate to a mechanical device for handling a releasable product assembly having at least one workpiece part and a residual grid.

### BACKGROUND

During the separating workpiece machining of a plate-like workpiece, in particular a sheet metal, by means of a separating device, for example by means of a laser separating device, the processing products are workpiece parts and a residual grid that at least partially encloses the workpiece parts. To simplify the removal of the processed products from the separating device, it is possible to not completely separate the workpiece parts from the residual grid during the separating workpiece processing. Instead, microjoints or nanojoints are left between the residual grid and the workpiece parts, which allow the residual grid and the workpiece parts to be handled as a unit when unloading the separating device. In addition, it is possible that workpiece parts produced during the separating machining are held in the residual grid due to thermal stresses, or as a result of canting after the separating process. It is also possible that larger workpiece parts that cannot tilt are not fixed in the residual grid. The workpiece part(s) and the residual grid form a releasable product assembly. Releasing the workpiece parts from the residual grid takes place in a method step following the separating workpiece processing.

DE 10 2021 123 520 A1 describes a method for cutting at least one workpiece from a sheet metal panel, which comprises the following steps: directing a laser beam onto the sheet metal panel along a contour of the workpiece, wherein the sheet metal panel is cut through in a main region of the contour and wherein at least one connection remains between the workpiece and an adjacent part of the sheet metal panel in at least one connecting region of the contour, removing the at least one workpiece and the adjacent part connected thereto from the support, and separating the at least one workpiece from the adjacent part.

In the method described in DE 10 2021 123 520 A1, a group of workpieces can be formed which are connected to one another via connections along at least one common contour line of the workpieces. During removal, a removal device can engage one of the workpieces in the group. To separate the workpieces, the removal device can shake or jolt a respective residual grid part, i.e., move it back and forth jerkily. Due to the dynamic loads generated, the connections break and the workpieces fall out of the residual grid part and can be collected, for example, in a collecting container.

JP 2000094057 A describes a mechanical arrangement and a method for punching workpieces. At a punching station of the machine arrangement, a residual grid and workpiece parts are produced from a plate-shaped material that is unwound from a roll, whereby the workpiece parts are connected to the residual grid via microjoints after completion of the punching workpiece processing. The assembly of the residual grid and the workpiece parts connected thereto is moved to a separation station where several pairs of rollers follow one another in a direction of movement of the residual grid and the workpiece parts, and are alternately offset upwards and downwards relative to one another perpendicular to the direction of movement of the residual grid and the workpiece parts. A gap is formed between the rollers of each pair of rollers. Coming from the punching station, the residual grid with the workpiece parts passes through the gap on several pairs of rollers that follow one another in the direction of movement, whereby the residual grid with the workpiece parts is bent several times. At the same time, the residual grid with the workpiece parts is vibrated in a manner perpendicular to the direction of movement. As a result, the microjoints remaining between the residual grid and the workpiece parts break during the punching sheet metal processing, and the workpiece parts released from the residual grid fall onto a product tray.

EP4257285A1 describes a transport system for separating a skeleton from a product. The transport system has a gripper device and a lifting device. The gripper device comprises a plurality of long side grippers for gripping the long sides of an outer frame of the skeleton and a plurality of short side grippers for gripping the short sides of the outer frame of the skeleton. The lifting device relatively raises or lowers the gripping device that grips the outer frame and the product, thereby separating the outer frame from the product. The transport system can comprise a pallet and a carrier that ascends or descends relative to the pallet. The pallet can include a pallet frame having a plurality of support plates, and the carrier can include a plurality of lifting plates ascending or descending between the plurality of support plates. The workpiece supported by the lifting plates can be gripped by the gripper device on the outer frame.

### SUMMARY

Embodiments of the present invention provide a method for handling a releasable product assembly having at least one workpiece part and a residual grid. The method includes releasing the at least one workpiece part from the residual grid by using at least one vibration generator at a separation station, and fixing the product assembly to a holding device, which engages underneath the product assembly at an edge side thereof with at least one holding member. The releasing the at least one workpiece part from the residual grid takes place on the product assembly fixed by the holding device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a mechanical device for handling a releasable product assembly, which is placed at a transfer station on a product pallet, which has two functional states, according to some embodiments;

FIG. 2 shows a schematic representation of the mechanical device of FIG. 1 during transport of the product pallet from the transfer station to a separation station, according to some embodiments;

FIG. 3 shows the product pallet according to FIGS. 1 and 2 in a first functional state according to some embodiments;

FIG. 4 shows the product pallet according to FIG. 3 in a second functional state according to some embodiments;

FIG. 5 shows a sectional view of the product pallet according to FIG. 3 in a sectional plane V indicated in FIG. 3, according to some embodiments;

FIG. 6 shows a schematic representation of the separation station with the product pallet loaded with the releasable product assembly according to some embodiments;

FIG. 7 shows the separation station according to FIG. 6 in the vertical view in the direction of arrow V in FIG. 6 according to some embodiments; and

FIG. 8, FIG. 9, FIG. 10, FIG. 11 and FIG. 12 show the processes at the separation station according to FIGS. 6 and 7, based on the conditions shown in FIGS. 6 and 7 according to some embodiments.

### DETAILED DESCRIPTION

Embodiments of the present invention provide a method and a mechanical device for handling a releasable product assembly, which enable a process-reliable and simple handling of a product assembly, in particular when releasing workpiece parts from a residual grid of the product assembly.

According to embodiments of the invention, a method includes releasing the at least one workpiece part from the residual grid by means of at least one vibration generator at a separation station, and fixing the product assembly to a holding device which engages underneath the product assembly at the edge side thereof with at least one holding member, wherein the release of the at least one workpiece part from the residual grid takes place on the product assembly fixed by means of the holding device.

The holding device serves to fix the product assembly effectively in the direction of gravity before the release and during the release of at least one workpiece part from the residual grid of the product assembly. The holding device also serves to fix the residual grid effectively in the direction of gravity after the at least one workpiece part has been released from the residual grid.

In the method described here, a holding device is used to fix the product assembly, which has at least one holding member that engages under the product assembly at the edge thereof and by means of which the product assembly can be effectively fixed at the edge thereof in the direction of gravity. The product assembly of the residual grid and the workpiece parts or the residual grid alone are typically effectively fixed to the edge in the vertical direction by means of the holding device.

The holding members can, for example, be grippers that grip the product assembly or the residual grid at the edge thereof. The grippers can, for example, press or clamp the product assembly against a base plate of the holding device to fix it. By fixing or clamping using the holding device, an automated release of the workpiece parts from the remaining workpiece can be carried out using the vibration generator. The workpiece parts are released from the remaining workpiece in a controlled manner and fall under the effect of gravity onto a product storage area arranged below the product assembly.

In one variant, the product assembly is picked up from a product pallet at the separation station using the holding device. In this case, the holding device fixes the product assembly resting on the product pallet in the separation station. The product pallet is designed to allow the holding member(s) of the holding device to grip underneath the edge sides thereof. For this purpose, the product pallet includes support members designed for the joint storage of at least one workpiece part and the residual grid in the direction of gravity. By way of example, the support members can be support bars or the like.

In this case, the product assembly is lifted from the product pallet by means of the holding device to enable the workpiece parts to be released from the residual grid by means of the vibration generator. The workpiece parts released from the residual grid by the vibrations fall downwards under the effect of gravity onto a product support arranged at the separation station, while the residual grid remains on the holding device.

It is possible that the product pallet from which the product assembly is picked up is transported out of the separation station before the workpiece parts are released from the residual grid and/or that the product pallet serves as a product support for the workpiece parts released from the residual grid.

In general, the workpiece parts released from the residual grid can be placed on any suitable product support that is arranged at the separation station or that is positioned at the separation station for this purpose. For example, the product support can form a platform or be designed as a conveyor belt that is moved back and forth between the separation station and a removal station for removing the workpiece parts with the aid of a transport device, or that is permanently arranged at the separation station and extends from the separation station to the removal station. In the latter case, the workpiece parts in the separation station can fall under the effect of gravity onto the conveyor belt, which transports the workpiece parts to the removal station.

In one variant of the method, the product assembly is transported from a transfer station to the separation station by means of a transport device. The transport device for transporting the product assembly from the transfer station to the separation station can be designed in various ways. The product assembly can be transported to the transfer station, for example, from a separation station of a separation device, for example a laser separation device. It is also possible to transport the product assembly from a storage station of a storage system to the transfer station. In this case, a suitably designed transport device, for example in the form of a driverless transport system, can transport the product assembly from the storage station of the storage system to the transfer station. A partially automated transport to the transfer station is also possible.

In a further development of this variant, the product assembly is stored on the product pallet and transported from the transfer station to the separation station by means of the transport device. In this case, the product assembly is preferably placed on the product pallet at the transfer station. In this case, the product pallet can have a guide device, e.g., in the form of guide rollers, which interact with stationary guide rails of the transport device to transport the product pallet with the product assembly stored thereon from the transfer station to the separation station.

The transport of the product assembly from the separation station to the transfer station can also be carried out using a product pallet on which the product assembly is stored. It is possible that different product pallets are used for transporting the product assembly from the separation station to the transfer station and for transporting the product assembly from the transfer station to the separation station. In this case, it is possible, for example, for the product assembly to be picked up at the transfer station by means of a handling device having a support, e.g., a rake or the like, which engages underneath the product assembly and lifts it from a first product pallet which serves to transport the product assembly between the separation station and the transfer station. In this case, after the product assembly has been lifted, the first product pallet can be replaced by a second product pallet, which is used to transport the product assembly from the transfer station to the separation station. In this case, the product assembly is placed on the second product pallet by the handling device at the transfer station. The handling device can have a lifting device to raise or lower the support that engages under the product assembly.

In a further development, the product pallet has a rectangular pallet frame with two frame leg pairs, wherein a first of the frame leg pairs has a first guide device by means of which the product pallet is guided during transport from the transfer station to the separation station and/or a second of the frame leg pairs has a second guide device by means of which the product pallet is transported from the separation station to a removal station. For example, guide systems with guide rollers can be used as guide devices, which interact with associated guide rails when the product pallet moves. During transport from the transfer station to the separation station or from the separation station to the removal station, the product pallet is guided in the longitudinal direction of a respective frame leg pair provided with a guide device.

The transport of the product pallet from the transfer station to the separation station can be carried out by means of a guide device of a longitudinal frame leg pair or by means of a guide device of a transverse frame leg pair of the pallet frame. The pallet frame can be guided from the separation station to the removal station using a guide device on the other frame leg pair. In this way, the product pallet can be transported along the long side thereof or along the short side thereof using the two guide devices.

In a further development, the product pallet has an element unit provided with support members, which comprises one of the frame leg pairs, and an area unit provided with a support surface, which comprises the other frame leg pair, wherein in a first functional state of the product pallet, in which the support members of the element unit protrude upwards relative to the support surface of the area unit, the product assembly is received by means of the holding device and wherein in a second functional state of the product pallet, in which the support members of the element unit do not protrude upwards relative to the support surface of the area unit, workpiece parts released from the residual grid are placed on the product pallet.

In this variant, the product assembly is picked up from the product pallet in the first functional state in which the holding device engages under the product assembly with the holding member(s). Before the workpiece parts are separated, the product pallet is transferred to the second functional state in which the support members do not protrude upwards above the support surface of the area unit. In the second functional state, the product pallet preferably forms a flat support surface on the upper side thereof, which particularly enables a gentle and orderly storage of the workpiece parts released from the residual grid.

To change from the first functional state to the second functional state, the element unit of the product pallet and the area unit of the product pallet can be moved vertically relative to each other either into a first relative position or into a second relative position. A lifting device can be provided at the separation station for delivering the product pallet in the two relative positions.

In the product pallet described here, the guide device on one of the frame leg pairs can be used in the first relative position of the element unit and the area unit, and thus in the first functional state of the product pallet, to transport the product assembly from the transfer station to the separation station. The guide device on the other frame leg pair can be used in the second relative position of the element unit and the area unit and thus in the second functional state of the product pallet to transport the workpiece parts which rest on the support surface of the product pallet after being released from the residual grid. At the removal station, the workpiece parts can be sorted automatically or manually from the typically flat support surface of the product pallet.

In a further development, the product pallet with the product assembly placed thereon is grasped at the transfer station by means of a support of the transport device and transported to the separation station. In this variant, the product pallet is fully or, if necessary, partially automated, for example by means of a crane, a forklift, or the like, and transported from the transfer station to the separation station and placed there. After the holding device at the separation station has gripped the product assembly at the edge sides thereof and fixed it, the product pallet can be transported back to the transfer station by means of the transport device without the product assembly stored thereon to subsequently place another product assembly on the product pallet. In this further development, the product pallet is generally not switchable between two functional states, i.e., it is a conventional product pallet that has only one functional state, in which support members for the storage of the product assembly protrude upwards over a support surface. In principle, however, it is also possible in this case to use a product pallet that can be converted into two functional states.

In an alternative variant, the product assembly is gripped under a support of the transport device at the transfer station and transported to the separation station resting on the support. In this variant, the transport of the product assembly is carried out with the aid of a transport device which grips underneath the product assembly by means of a suitable support, for example by means of a rake or the like. In this case, the product assembly can be gripped at the transfer station using the support, lifted from a product pallet and transported to the separation station.

The product assembly can be placed at the separation station by means of the transport device on a product pallet that has two functional states or only one functional state. However, it is also possible for the product assembly to be picked up by the holding device at the separation station while resting on the support of the transport device, in that at least one holding member of the holding device engages under the edge side of the product assembly. In this case, it is advantageous if the support of the handling device is designed in the form of a rake or the like, since this simplifies the fixing to the holding device.

In a further alternative variant, the product assembly is gripped at the edge side thereof by at least one holding member of the holding device at the transfer station and transported to the separation station by means of the holding device. In this case, the holding device forms the transport device. In this case, a product pallet or a conveyor belt, for example, can be arranged at the separation station as a product storage device, onto which the workpiece parts fall after being released from the residual grid. The workpiece parts can be transported from the separation station to a removal station to sort them from the product support.

In all variants described above, the residual grid fixed to the holding device can be thrown off by releasing the fixation and fall under the effect of gravity, for example, into a trough, a residual grid trolley, or the like. For this purpose, the holding device with the residual grid attached thereto can also be transported to a storage station for the storage or discharge of the residual grid.

A further aspect of the invention relates to a mechanical device comprising at least one vibration generator for releasing at least one workpiece part from the residual grid at a separation station, and a holding device for fixing the product assembly, which has at least one holding member for engaging underneath the edge side of the product assembly, wherein the mechanical device is designed to release the at least one workpiece part from the residual grid on the product assembly fixed by means of the holding device.

The at least one vibration generator can form a separation unit together with the holding device. By means of at least one vibration generator, the holding device with the product assembly can be shifted into oscillation or vibration. Due to the vibration of the product assembly, the workpiece parts are released from the residual grid, typically by breaking up micro-or nanojoints remaining between the workpiece parts and the residual grid. After the release of the workpiece parts, the residual grid remains on the holding device, while the workpiece parts fall under the effect of gravity onto a product tray located at the separation station below the holding device.

In one embodiment, the mechanical device comprises a transport device for transporting the product assembly from a transfer station of the mechanical device to the separation station. The transport device can be designed in various ways.

In a further development of this embodiment, the mechanical device has a product pallet for supporting the product assembly, wherein the transport device is designed to transport the product pallet with the product assembly stored thereon from the transfer station to the separation station. In this embodiment, the transport device typically has a drive to move the product pallet from the transfer station to the separation station along guide rails of the transport device.

In a further development of this embodiment, the product pallet has a rectangular pallet frame with two frame leg pairs, wherein a first of the frame leg pairs has a first guide device for guiding the product pallet during transport from the transfer station to the separation station and/or wherein a second of the frame leg pairs has a second guide device for guiding the product pallet during transport from the separation station to a removal station.

As described above in connection with the method, the guide devices can have guide rollers or consist of guide rollers which interact with associated guide rails of the transport device to move the product pallet. During transport from the transfer station to the separation station and/or from the separation station to the removal station, the product pallet is guided in the longitudinal direction of a respective frame leg pair provided with a guide device.

In a further development of this embodiment, the product pallet has an element unit provided with support members, which comprises one of the frame leg pairs, and an area unit provided with a support surface, which comprises the other frame leg pair, wherein the element unit and the area unit can be converted from a first functional state, in which the support members of the element unit protrude upwards relative to the support surface of the area unit, into a second functional state, in which the support members of the element unit do not protrude upwards relative to the support surface of the area unit. In the second functional state, the product pallet preferably has a flat support surface. The transition between the first functional state and the second functional state can be effected by a movement of the element unit and the area unit in the vertical direction between a first relative position and a second relative position. For movement between the first relative position and the second relative position, the mechanical device can, for example, have a lifting device arranged at the separation station.

In an alternative embodiment, the transport device is designed to grip the product pallet with the product assembly stored thereon at the transfer station with a support, and to transport it to the separation station while resting on the support. In this case, the transport device typically has a lifting device which is designed to lift the support when it engages under the product pallet at the transfer station. The lifting device is also used to place the support with the product pallet stored thereon at the separation station.

In a further alternative embodiment, the transport device has a support for engaging underneath the product assembly and is designed to transport the product assembly resting on the support from the transfer station to the separation station. As described above in connection with the method, the support can be designed, for example, in the form of a rake or the like.

In a further alternative embodiment, the transport device is formed by the holding device, which is designed to engage the product assembly at the transfer station with the at least one holding member at the edge side thereof and to transport it to the separation station. At the transfer station, the product assembly can rest, for example, on the support members of a product pallet, which enable the product assembly to be gripped underneath by means of at least one holding member.

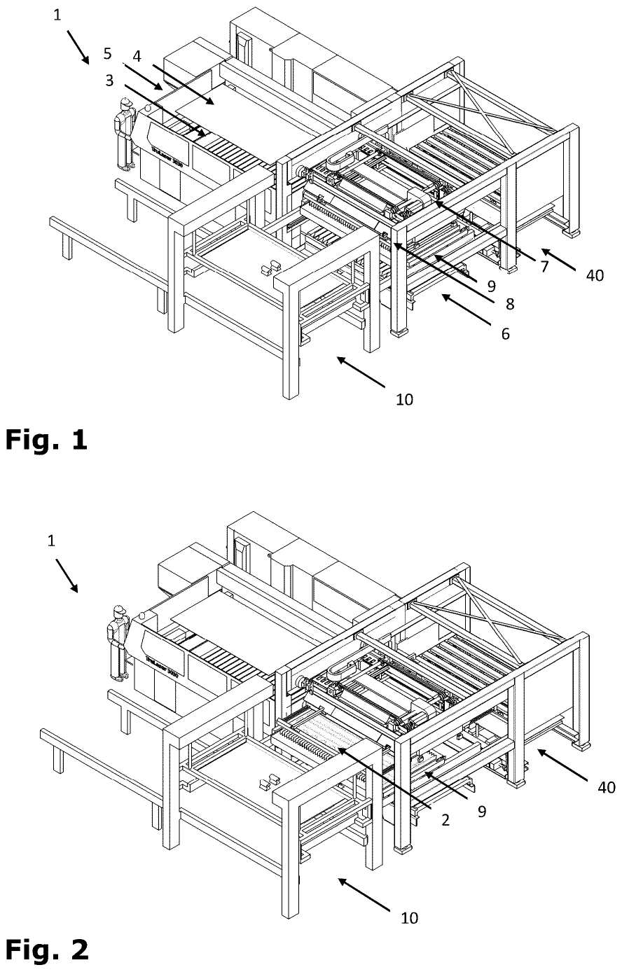

FIG. 1 and FIG. 2 show a mechanical device 1 for handling a releasable product assembly 2, which has workpiece parts 36 and a residual grid 37 (see FIG. 11 and FIG. 12). The releasable product assembly 2 was produced by separating a raw sheet 4 on a laser cutting machine 5. The laser cutting machine 5 forms a cutting station of the mechanical device 1. During separating sheet metal processing, the releasable product assembly 2 was formed by leaving nanojoints between the workpiece parts 36 and the residual grid 37.

In a working space of the laser cutting machine 5, the raw sheet 4 was stored on a product pallet 3 during the separating processing. After completion of the separating sheet metal processing, the product pallet 3, now loaded with the releasable product assembly 2, is removed from the working space of the laser cutting machine 5 and transferred to a transfer station 6 of the mechanical device 1.

At the transfer station 6, the product assembly 2 is picked up by a handling device 7, in which a rake support 8 of the handling device 7 engages under the product assembly 2 stored on the product pallet 3 and lifts it out. Subsequently, a product pallet 9 is transferred to the transfer station 6, which has two functional states, as described in more detail below. The handling device 7 places the product assembly 2 on the product pallet 9 with the two functional states, and the rake support 8 is opened. The rake support 8 stands out from the product pallet 9. The product pallet 9 with the product assembly 2 placed thereon is transported in a subsequent step from the transfer station 6 to a separation station 10 of the mechanical device 1, as indicated in FIG. 2.

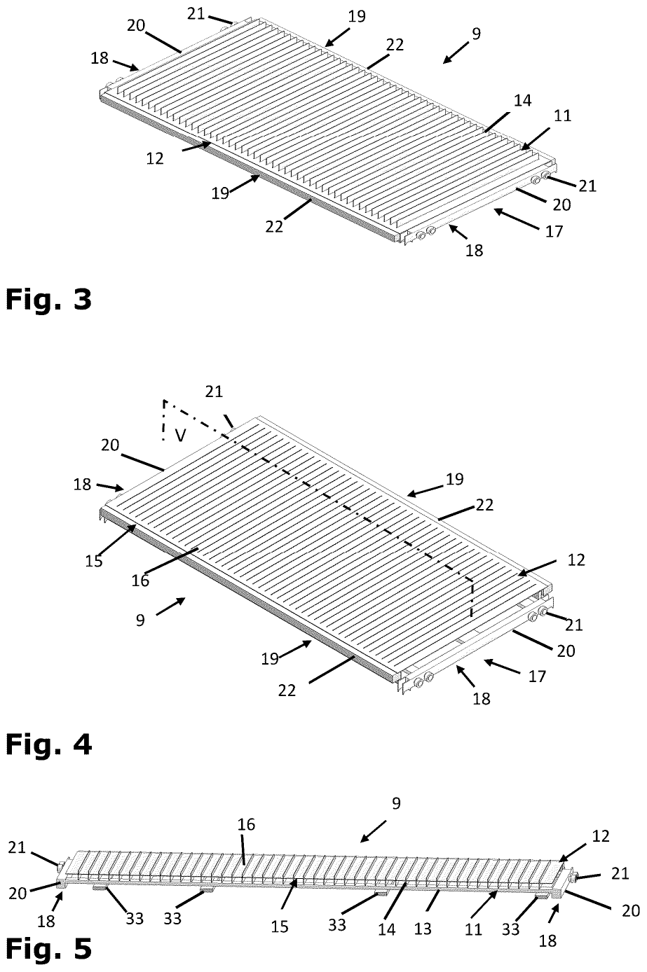

FIGS. 3 to 5 show the product pallet 9 with the two functional states, which comprises an element unit 11 and an area unit 12. The element unit 11 of the product pallet 9 has as the base thereof a base plate 13 (FIG. 5), on which support members of the element unit 11 designed as support strips 14 protrude upwards. With the base plate 13, the element unit 11 is arranged below a support plate 15 of the area unit 12 of the product pallet 9. The support plate 15 has a support surface 16 on the upper side thereof and is provided on the support surface 16 with through-openings indicated by lines for the support strips 14 of the element unit 11.

A rectangular pallet frame 17 of the product pallet 9 comprises two frame leg pairs 18, 19, of which the frame leg pair 18 is part of the element unit 11 and the frame leg pair 19 is part of the area unit 12.

Each of the frame legs 20 of the frame leg pair 18 of the element unit 11 is provided with a guide device in the form of guide rollers 21. The guide rollers 21 guide the product pallet 9 during movements in the longitudinal direction of the frame legs 20 of the element unit 11.

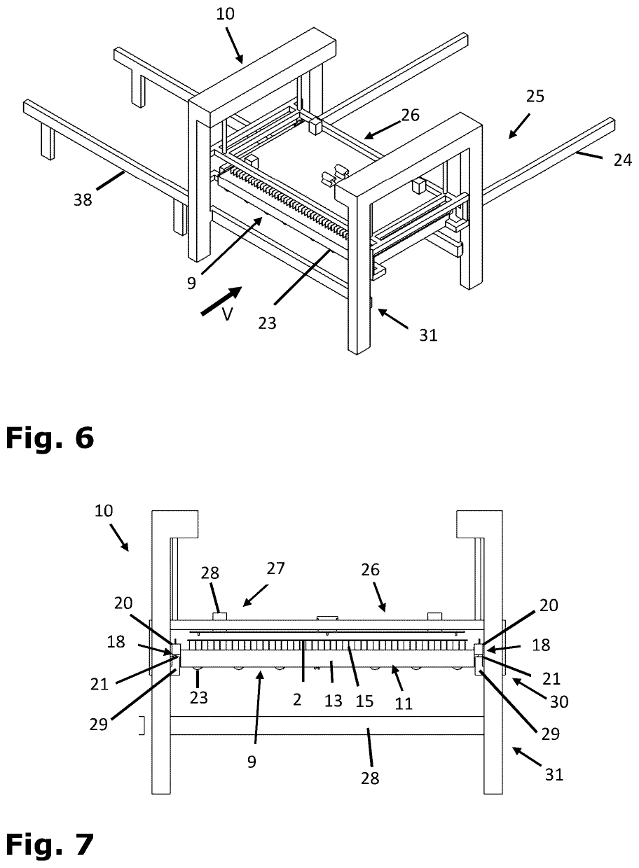

Accordingly, guide rollers 23 are provided on the frame legs 22 of the frame leg pair 19 of the area unit 12 as a guide device (see FIG. 6). By means of the guide rollers 23, the product pallet 9 is guided during movements in the longitudinal direction of the frame legs 22 of the area unit 12.

The element unit 11 and the area unit 12 of the product pallet 9 can be adjusted vertically relative to each other. This allows the product pallet 9 to be transferred into a first functional state and into a second functional state.

In the first functional state shown in FIG. 3 and present in a first relative position of the element unit 11 and the area unit 12, the product pallet 9 serves to support the product assembly 2 described above jointly in the direction of gravity by means of the support strips 15 projecting upwards relative to the support surface 16 of the product pallet 9.

In the second functional state shown in FIG. 4 and in an associated second relative position of the element unit 11 and the area unit 12, the support strips 15 of the element unit 11 do not project upwards relative to the support plate 15 of the area unit 12 on the processing product side. Consequently, the product pallet 9 forms a flat support surface 16 on the upper side thereof, which is used in the manner described below for the sole storage of workpiece parts 36 which are released from the residual grid 37 in the separation station 10.

During the movement from the transfer station 6 to the separation station 10 described in connection with FIG. 2, the product pallet 9 is in the first functional state thereof. During transport, the product pallet 9 is guided by means of the guide rollers 23 of the element unit 11 on guide rails 24 which extend to the separation station 10 (FIG. 6). The guide rails 24, together with the guide rollers 23 and a drive not pictorially shown, form a transport device 25 for transporting the product pallet 9 from the transfer station 6 to the separation station 10.

FIGS. 6 to 9 show the separation station 10 with the product pallet 9 on which the product assembly 2 is deposited. Above the product pallet 9 loaded with the product assembly 2, a separation unit 26 is shown in FIGS. 6 to 9.

The separation unit 26 is provided with a holding device 27. The holding device 27 has holding members in the form of grippers 28 which, after the product pallet 9 loaded with the product assembly 2 has been moved into the separation station 10, are still in the starting position thereof in which they are arranged outside the product assembly 2 in the vertical projection into the plane of the product assembly 2.

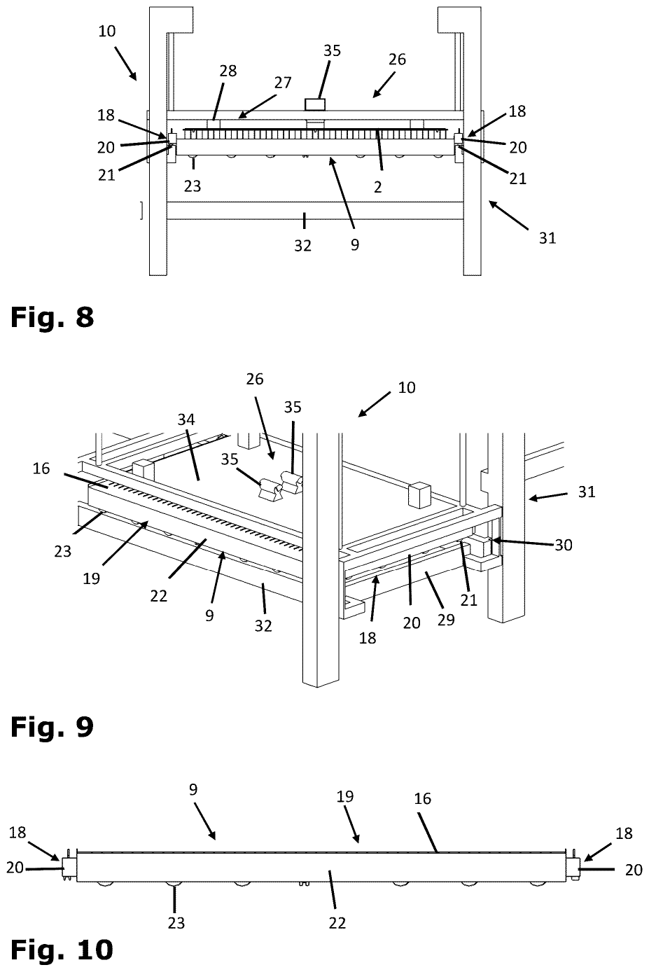

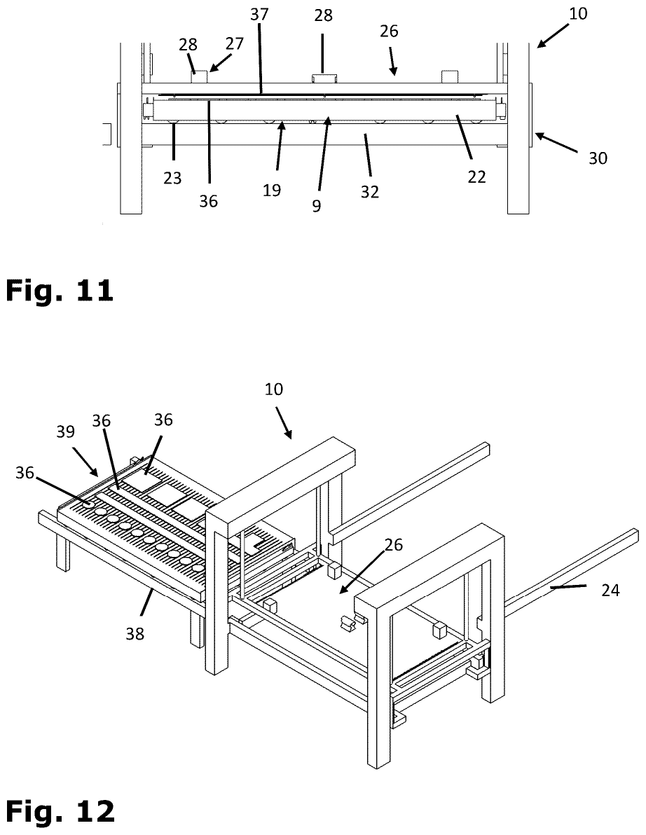

Based on these conditions, the grippers 28 of the holding device 27 are moved into a position in which they grip the product assembly 2 from below at the edge sides thereof (FIG. 8).

In FIGS. 6 to 8, the product pallet 9 is supported by the guide rollers 23 of the frame leg pair 18 of the element unit 11 on horizontal supports 29 of a lifting device 30 aligned with the guide rails 24 in the direction of gravity. The horizontal supports 29 of the lifting device 30 can be raised and lowered by a motor on a support frame 31 of the separation station 10.

In FIGS. 6 to 8, the area unit 12 of the product pallet 9 is mounted in the direction of gravity on the base plate 13 of the element unit 11. The frame legs 22 of the area unit 12 with the guide rollers 23 provided thereon are spaced in the vertical direction from a support 32 which is fixedly mounted on the support frame 31 of the separation station 10.

Based on the conditions shown in FIG. 8, the product pallet 9 loaded with the product assembly 2 and the separation unit 26 are lowered jointly by means of the lifting device 30.

During the lowering movement, the product pallet 9 rests on the support 32 on the supporting frame 31 with the guide rollers 23 provided on the frame legs 22 of the area unit 12.

As the product pallet 9 continues to move lower, the element unit 11 of the product pallet 9 moves downwards relative to the area unit 12, which is now fixed in the direction of gravity. As a result, the second relative position of the element unit 11 and the area unit 12 and, associated therewith, the second functional state of the product pallet 9 results, in which a flat support surface 16 is formed on the upper side of the product pallet 9 (FIGS. 9, 10).

The guide rollers 21 on the frame legs 22 of the element unit 11 are now located at a distance above the horizontal supports 29 of the lifting device 30. The element unit 11 is mounted with the base plate 13 on stops 33 provided for this purpose (FIG. 5) on the area unit 12 in the direction of gravity.

If necessary, the first relative position of the element unit 11 and the area unit 12 could be restored by lifting the element unit 11 relative to the area unit 12 supported on the support 32.

During the lowering movement of the product pallet 9, the product assembly 2 is pulled or clamped to the underside of a vibration plate 34 of the separation unit 26 by means of the holding device 27. On the upper side of the vibration plate 34, vibrators 35 are arranged as vibration generators, which set the vibration plate 34 into vertical vibrations after the product pallet 9 has been transferred into the second functional state. Due to the vibrations of the vibration plate 34, the workpiece parts 36 are released from the residual grid 37, which is still fixed to the separation unit 26 by means of the holding device 27. Under the effect of gravity, the workpiece parts 36 separated from the residual grid 37 are placed gently and in an orderly manner on the flat support surface 16 of the product pallet 9 (FIG. 11).

Any workpiece parts present in the residual grid 37 that are not connected to the residual grid 37 via micro-or nanojoints are not fixed by the holding device 27. These remain on the support bars 14 and are lowered together with the support bars 14 when the product pallet 9 is transferred from the first to the second functional state.

Guide rails 38 arranged outside the separation station 10 are aligned with the support 32 on the supporting frame 31 of the separation station 10 (FIG. 12). The product pallet 9, now loaded only with the workpiece parts 36, moves from the separation station 10 to a removal station 39 via the guide rails 38. The product pallet 9 is guided on the guide rails 38 by means of the guide rollers 23 provided on the frame legs 22 of the area unit 12. At the removal station 39, the workpiece parts 36 resting on the product pallet 9 are sorted manually or automatically, e.g., by means of a suction gripper.

The residual grid 37 fixed to the separation unit 26 is removed separately from the separation station 10. For this purpose, the grippers 28 are released from the residual grid 37, whereby the residual grid 37 is dropped under the effect of gravity onto a suitable support, for example onto a residual pallet or into a trough. The discharge of the residual grid 37 can take place at the separation station 10 or at another location. For example, the residual grid 37 can be transported to a warehouse and stored there.

As an alternative to the transport of the product pallet 9 from the transfer station 6 to the separation station 10 along the guide rails 24 described above, the handling device 7 described above can also serve as a transport device for transporting the product pallet 9 from the transfer station 6 to the separation station 10. In this case, as described above, the product assembly 2 resting on the product pallet 3, which only has the first functional state, is gripped and lifted by the rake support 8 at the transfer station 6. The handling device 7 is subsequently moved from the transfer station 6 to the separation station 10 and places the product assembly 2 on the product pallet 9 arranged at the separation station 10. After the product assembly 2 has been deposited from the separation station 10, the handling device 7 is moved back to the transfer station 6.

From the transfer station 6, the handling device 7 can be moved further to a receiving station 40 shown in FIG. 1 and FIG. 2 to receive a raw sheet 4 and place it on the product pallet 3 arranged at the transfer station 6. In parallel, the method sequence described above is carried out at the separation station 10 to release the workpiece parts 36 from the residual grid 37. Alternatively, the picking up of raw sheets at the picking station 40 and the transport to the transfer station 6 can be carried out in a manner other than by means of the handling device 7, for example by means of a suction device or the like.

When using the handling device 7 for transporting the product assembly 2 from the transfer station 6 to the separation station 10, it is also possible for the product assembly 2 to be resting on the rake support 8 and to be gripped and fixed at the edge sides thereof by the grippers 28 of the holding device 27. In this case it is possible to dispense with the product pallet 9. In this case, any product support for depositing the workpiece parts 36 can be arranged in the separation station 10, for example a conveyor belt or the like. The conveyor belt can, for example, extend from the separation station 10 to the removal station 39, at which the workpiece parts 36 are sorted from the conveyor belt. In this case, the residual grid 37 can be picked up by the rake support 8 and transported out of the separation station 10 or dropped off at the separation station 10.

The transport of the product assembly 2 from the transfer station 6 to the separation station 10 can also be carried out with the aid of the holding device 27, which in this case is moved between the transfer station 6 and the separation station 10 by means of a suitable drive. In this case, the holding device 27 engages under the edge side of the product assembly 2 at the transfer station 6 by means of the grippers 28 and fixes same. The product assembly 2 is transported from the transfer station 6 to the separation station 10 in the state of being fixed to the holding device 27. In the separation station 10, the workpiece parts 36 are released from the residual grid 37 by means of the vibration generator 35 in the manner described above. In this case, it is possible to place the product assembly 2 at the separation station 10 by means of the holding device 27 onto the product pallet 9 described above, which is transferred from the first to the second functional state. Alternatively, another type of product support can be arranged at the separation station 10 below the holding device 27, for example a conveyor belt or the like. The discharge of the residual grid 37 from the holding device 27 can be carried out in the manner described above.

A further possibility for transporting the product assembly 2 from the transfer station 6 to the separation station 10 is to transport the product pallet 3 shown in FIG. 1, which only has the first functional state, with the product assembly 2 placed thereon from the transfer station 6 to the separation station 10. For this purpose, the product pallet 3 can be lifted at the transfer station 6 by means of a transport device, e.g., in the form of a crane, a forklift, or the like, transported to the separation station 10 and deposited there. In this case, too, the product assembly 2 is fixed to the holding device 27 by means of the grippers 28, and the method sequence described above for releasing the workpiece parts 36 from the residual grid 37 is carried out. After fixing the product assembly 2 to the holding device 27 and lifting the product assembly 2 from the product pallet 3, in this case the product pallet 3 is moved out of the separation station 10 and can be moved back to the transfer station 6, for example by means of a transport device in the form of a crane, forklift, or the like. The product pallet 9 described above with the two functional states or another product support, for example a conveyor belt or the like, is subsequently arranged at the separation station 10.

After the workpiece parts 36 are released from the residual grid 37, the vibration generators 35 are activated and the workpiece parts 36 fall onto the product pallet 9 or onto another product support. The workpiece parts 36 are transported to the removal station 39 for sorting by means of the product pallet 9 or in another way. The residual grid 37 fixed to the holding device 27 is subsequently ejected by releasing the clamping by the grippers 28, and can be deposited, for example, in a trough or in a residual grid trolley.

It is also possible that the product assembly 2 is not transported from the separation station or from the laser cutting machine 5 to the transfer station 6 of the mechanical device 1. In this case, the product assembly 2 can be removed from a warehouse or the like in an automated or semi-automated manner and transported to the transfer station 6.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for handling a releasable product assembly having at least one workpiece part and a residual grid, the method comprising:
releasing the at least one workpiece part from the residual grid by using at least one vibration generator at a separation station, and
fixing the product assembly to a holding device, which engages underneath the product assembly at an edge side thereof with at least one holding member, wherein the releasing the at least one workpiece part from the residual grid takes place on the product assembly fixed by the holding device.

2. The method according to claim 1, wherein the product assembly is picked up from a product pallet at the separation station by the holding device.

3. The method according to claim 1, wherein the product assembly is transported from a transfer station to the separation station by a transport device.

4. The method according to claim 3, wherein the product assembly is transported from the transfer station stored on the product pallet to the separation station by the transport device.

5. The method according to claim 4, wherein the product pallet has a rectangular pallet frame with two frame leg pairs, wherein a first pair of the frame leg pairs has a first guide device for guiding the product pallet during transport from the transfer station to the separation station, and/or a second pair of the frame leg pairs has a second guide device for transporting the product pallet from the separation station to a removal station.

6. The method according to claim 5, wherein the product pallet has an element unit provided with support members and an area unit provided with a support surface, wherein the element unit comprises one of the frame leg pairs, and the area unit comprises another one of the frame leg pairs, wherein in a first functional state of the product pallet, the support members of the element unit protrude upwards relative to the support surface of the area unit, and the product assembly is received by the holding device, and wherein in a second functional state of the product pallet, the support members of the element unit do not protrude upwards relative to the support surface of the area unit, and the at least one workpiece part released from the residual grid is placed on the product pallet.

7. The method according to claim 4, wherein the product pallet with the product assembly stored thereon is gripped by a support of the transport device at the transfer station and is transported to the separation station resting on the support.

8. The method according to claim 3, wherein the product assembly is gripped under a support of the transport device at the transfer station and is transported from the transfer station to the separation station resting on the support.

9. The method according to claim 3, wherein the product assembly is gripped at the edge side thereof by the at least one holding member of the holding device at the transfer station, and is transported to the separation station by the holding device.

10. A mechanical device for handling a releasable product assembly which has at least one workpiece part and a residual grid, the mechanical device comprising:
at least one vibration generator for releasing the at least one workpiece part from the residual grid at a separation station, and
a holding device for fixing the product assembly, the holding device comprising at least one holding member for engaging underneath an edge side of the product assembly, wherein the mechanical device is configured to release the at least one workpiece part from the residual grid on the product assembly fixed by the holding device.

11. The mechanical device according to claim 10, further comprising:
a transport device for transporting the product assembly from a transfer station of the mechanical device to the separation station.

12. The mechanical device according to claim 11, further comprising:
a product pallet for supporting the product assembly, wherein the transport device is configured to transport the product pallet with the product assembly stored thereon from the transfer station to the separation station.

13. The mechanical device according to claim 12, wherein the product pallet comprises a rectangular pallet frame with two frame leg pairs, wherein a first pair of the frame leg pairs has a first guide device for guiding the product pallet during transport from the transfer station to the separation station, and/or wherein a second pair of the frame leg pairs has a second guide device for guiding the product pallet during transport from the separation station to a removal station.

14. The mechanical device according to claim 13, wherein the product pallet comprises an element unit provided with support members and an area unit provided with a support surface, wherein the element unit comprises one of the frame leg pairs, and the area unit comprises another one of the frame leg pair, wherein the element unit and the area unit is capable of being transferred from a first functional state, in which the support members of the element unit protrude upwards relative to the support surface of the area unit, into a second functional state, in which the support members of the element unit do not protrude upwards relative to the support surface of the area unit.

15. The mechanical device according to claim 12, wherein the transport device is configured to engage the product pallet with the product assembly mounted thereon at the transfer station with a support and to transport the product assembly resting on the support to the separation station.

16. The mechanical device according to claim 11, wherein the transport device has a support for engaging underneath the product assembly and is configured to transport the product assembly resting on the support from the transfer station to the separation station.

17. The mechanical device according to claim 11, wherein the transport device is formed by the holding device, which is configured to engage the product assembly at the transfer station with the at least one holding member at the edge side thereof and to transport the product assembly to the separation station.
